(19) United States
(12) Patent Application Publication
(10) Pub. No.: US 2005/0021552 A1
(43) Pub. Date: Jan. 27, 2005

(54) Video playback image processing

(76) Inventors: Jonathan Ackley, Glendale, CA (US); Christopher T. Carey, Santa Clarita, CA (US); Bennet S. Carr, Burbank, CA (US); Kathleen S. Poole, La Canada, CA (US)

Correspondence Address: GREENBERG TRAURIG LLP, 2450 COLORADO AVENUE, SUITE 400E, SANTA MONICA, CA, 90404, US

(21) Appl. No.: 10/859,887

(22) Filed: Jun. 2, 2004

Related U.S. Application Data
(60) Provisional application No. 60/475,252, filed on Jun. 2, 2003.

(51) Int. Cl. G06F 17/00

(52) U.S. Cl. 707/102; 707/104.1

(57) ABSTRACT

An animated image is dynamically generated for insertion into a video stream within a media playback device. The media playback device receives an animated image and executable. The media playback device receives meta-data associated with an animated image. The executable is executed in essentially real-time. The animated image is generated. In one instance, the animated image is a sprite. In another instance, a composite seamless integrated image of the animated image and the video stream is created. The meta-data and the executable persistently used will be stored in a memory device for future use. In another aspect, meta-data and executable associated with the video stream are streamed into the media playback device.

### RELATED APPLICATIONS

This application claims priority to U.S. Provisional Patent Application No. 60/475,252, filed Jun. 2, 2003, which is incorporated herein by reference in its entirety. This application is also related to U.S. Utility Patent Application No. ______ entitled “System And Method Of Programmatic Window Control For Consumer Video Players” (Docket No. 54317-026502); U.S. Utility Patent Application No. ______ entitled “System And Method Of Interactive Video Playback” (Docket No. 54317-026701); U.S. Utility Patent Application No. ______ entitled “System And Method Of Dynamic Interface Placement Based On Aspect Ratio” (Docket No. 54317-026801); and U.S. Utility Patent Application No. ______ entitled “System And Method Of Video Player Commerce” (Docket No. 54317-026901); all of which are filed concurrently herewith on Jun. 2, 2004, and incorporated by reference herein in their entirety.

### BACKGROUND

1. Field

This disclosure discusses processing video data on consumer video media playback devices. More particularly, this disclosure relates to providing interactive processing of video data to create custom visual effects and interactive characters.

2. General Background

Video and audio storage technology including video data storage capacity has rapidly increased over the last several years. For example, Digital Video Disk (DVD) technology has allowed large amounts of video data to be stored on a single data storage unit. DVD is actually a family of physical and application formats. Examples of this family include DVD-Video, DVD-Audio, and DVD-ROM. DVD may contain any combination of DVD-Video, DVD-Audio, and DVD-ROM formats. DVD-Video is primarily the video and the audio format used for movies, music concert videos, and other video based programming. As far as the physical characteristics, a DVD has the capability to hold anywhere from seven times to over twenty-five times the digital data on a single diskette compared to a single compact diskettes (CD).

However, even with this presently available large capacity for audio and video storage in DVD technology, there is a need to better utilize this technology and provide other advantages. Presently available video media playback devices have very limited capability. Video media playback devices including DVD players, DVD cameras, High Definition video players, Personal Computer (PC) DVD-ROM drives, and Video Cassette Recorder's (VCR's), provide very simple text overlays. For instance, a date or a time stamp, over the video stream as part of their menu options.

For more complicated video and graphics overlays, electronic programs like Adobe Photoshop, After Effects and Fractal Painter are being utilized. The presently available electronic programs have a drawback that the video stream needs to be imported into and edited within the electronic program.

Thus, there is a need by video developers for improving video processing techniques and providing solutions to the above mentioned problems and needs as well as providing other advantages over presently available video data processing techniques.

### SUMMARY

This disclosure provides for dynamically generating an animated image for insertion into a video stream. More specifically, an animated image is created for positioning or re-positioning within a video stream. An image is received. The image may be graphics or a character or a combination of both. In one aspect, video data is streamed into a video playback device such as meta-data with attributes associated with a sprite. In this aspect, the executable is received. The image is provided as an input to the executable. The meta-data associated with the image is another input to the executable. The executable is executed. The sprite is generated by the executable.

In one aspect, sprite meta-data including attributes of the sprite and sprite executable for essentially real-time generation of the sprite may be stored in the computer processor memory buffer for future use. The future use may involve utilizing stored animated images, instead of re-streaming in the animated images, for subsequent video data processing.

In another aspect, the video stream is stored in the computer processor memory device for future use. In another aspect, meta-data and executable are stored in the memory device for future use. In the alternative, the video stream and/or animated image is stored in the pre-stream memory device for future use. These stored animated images may be persistently stored-random based graphics including sprites and audio.

In one aspect, the executable is streamed through the media interface into the computer processor with the video stream and/or the animated image. In another aspect, the sidecar video streams drawing properties are streamed into the computer processor. In the alternative, the executable is programmable by an end-user. The sidecar video stream drawing properties may include scale, screen position, alpha blending data, stretch/skew information, and z-order.

In another aspect, the executable redefines basic functionality of the video playback device in response to an end-user input. In one aspect, the animated image includes visual effects and interactive characters appear to originate form the video stream. In yet another aspect, the animated image is an interactive image and the executable includes an edge detection algorithm. In the alternative, the behavior of the media playback device is redefined in response to the video stream and/or the animated image. The interactive images may be controlled in essentially real-time.

The foregoing and other objects, features, and advantages of the present disclosure will be become apparent from a reading of the following detailed description of exemplary embodiments thereof, which illustrate the features and advantages of the disclosure.

### BRIEF DESCRIPTION OF THE DRAWINGS

FIG. 1 is a block diagram of one embodiment of the media playback device containing a computer processor.

FIG. 2 is a flow diagram of one embodiment for custom compositing of video and graphics using a media playback device containing a computer processor.

FIG. 3 is a flow diagram illustrating media playback device functionality being modified in response to instructions from the computer processor.

FIG. 4 is a flow diagram illustrating during an interactive application an end-user input creates a change to the video display device.

FIG. 5 is a flow diagram illustrating blends of 2 dimensional image representations and 3 dimensional image representations on a screen shot.

FIG. 6 is a flow diagram illustrating a user-controlled character being programmed by the computer processor on a video display device.

FIG. 7 is a flow diagram illustrating images from the Internet being composited over the video stream.

FIG. 8 is a flow diagram including screen shots illustrating a picture-in-picture system being composited into a third video stream.

### DETAILED DESCRIPTION

In the following description of embodiments reference is made to the accompanying drawings, which form a part thereof, and in which are shown by way of illustration specific embodiments, which may be practiced. It is to be understood that other embodiments may be utilized and structural and functional changes may be made without departing from the scope of the present disclosure. The present disclosure provides a media playback device with an executable environment for custom compositing of video and graphics. In one aspect, the media playback device provides dynamically creating sprites on a video stream.

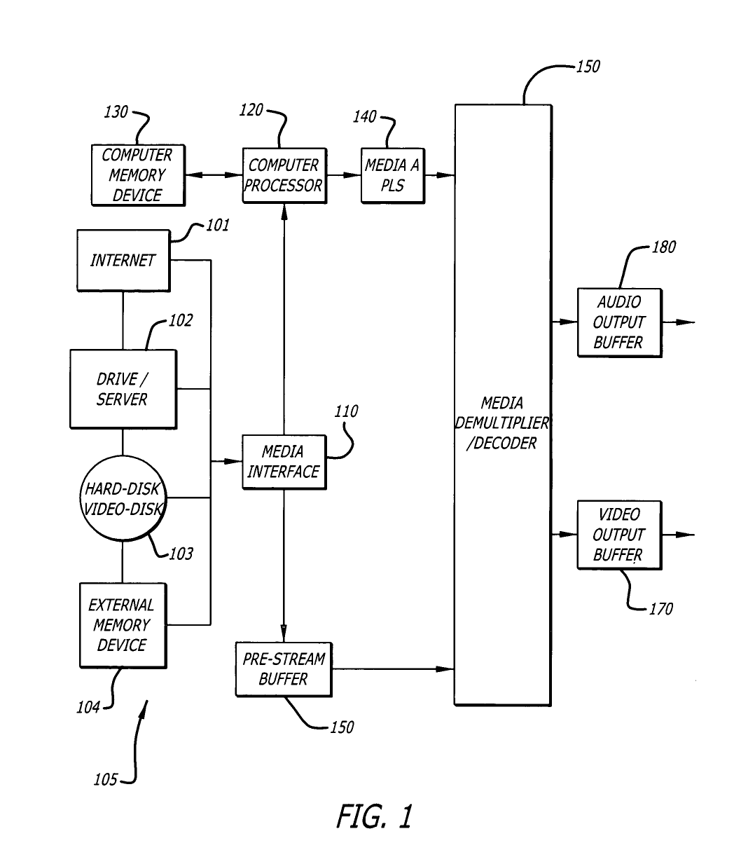

FIG. 1 is a block diagram of the media playback device containing a computer processor. Video data may be streamed into the media player from various sources 105 such as from an Internet connection 101, a drive/server 102, a hard-disk (HD) Video Disk, or an external memory device such as flash memory 104. The media playback device includes a media interface 110, a computer processor 120, a computer processor memory device 130, a media application programming interface (API) 140, a pre-stream buffer 150, a media demultiplexor/decoder 160, an audio output buffer 170 and a video output buffer 180. The operations and functioning of each of these components will be explained in detail in the accompanying figures and text.

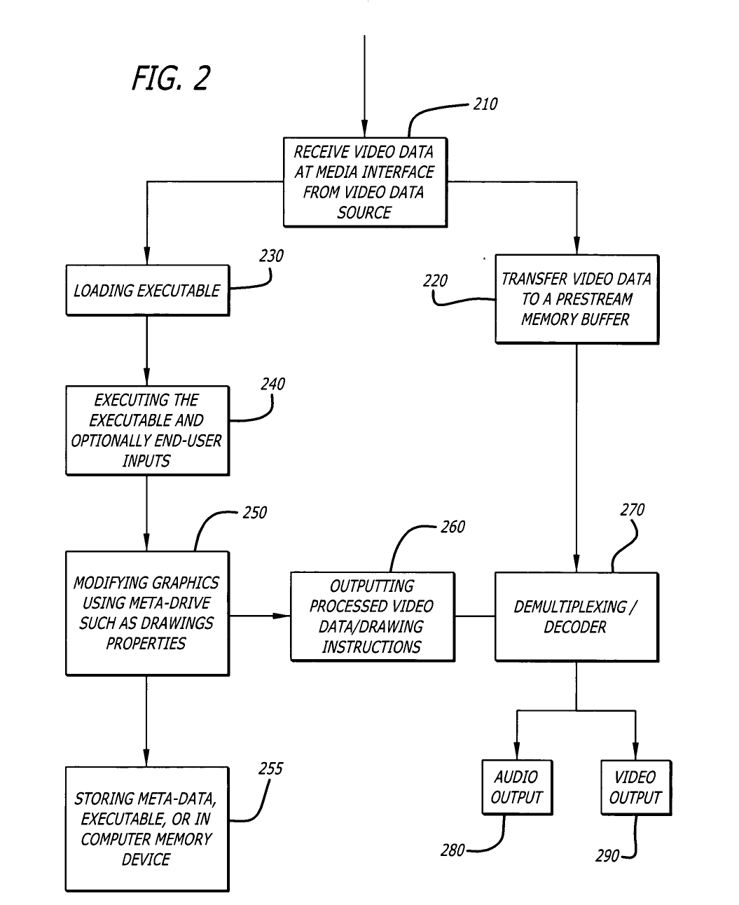

FIG. 2 is a flow diagram of an embodiment for custom compositing of video and graphics using a media playback device containing a computer processor. In one instance, video data is retrieved from a video data source as indicated at block 200.

In this embodiment, the video data source is a hard-disk (HD) video disk. Alternatively, the video data source may be an external memory device such as flash memory, a drive, a server, or the Internet. The video data may be a video or an audio stream such as sidecar video, sidecar audio, streamed sprites, trigger data, executable, sprite meta-data, and audio meta-data, and video stream meta-data. The sprite meta-data includes data elements, data attributes, data records, and data structures. Examples of sprite meta-data include position, scale, alpha, frame state, or the like. In one aspect, the meta-data may be associated with a video stream including attributes of the video stream. In yet another aspect, the meta-data may be associated with multiple video streams. An image is also received. The image may be resident on the computer, retrieved from an external memory location or an external memory device, a part of the video stream or streamed into the media playback device as part of the video data. The meta-data describes how the image will be modified, changed, or morphed.

The video data is received by a media interface of a media playback device as indicated in block 210. In this embodiment, the media interface is a Small Computer System Interface (SCSI) but may be any bus system that transfers video data between a memory device and a media playback device. In this embodiment, the media playback device may be any device that can play video data and optionally audio content of a pre-recorded video. The media interface transfers the video data to the computer processor and optionally the pre-stream data buffer. Further in this embodiment, media playback device is a DVD player. Media playback device may have control functions including play, stop, pause, skip forward and back, rewind, return to main menu, or the like. These control functions may be located on media playback device, media playback device remote control unit, and/or control function graphical images over the video stream.

In the alternative, media playback device may be a High-Definition (HD) video player, a Personal Computer (PC) DVD-ROM drive, or a software video decoder. Video data includes a video stream. In this embodiment, the video stream is a pre-recorded movie or video. In the alternative, the video stream may be any video data stream.

Video data is transferred to a pre-stream memory buffer within the media playback device as indicated in block 220. Video data including executable and video data requiring further processing are transferred to a computer processor within the media playback device as indicated in block 230.

Computer processor is a data central processing unit for audio and video streams such as a Turning-complete computer processor. Optionally the computer processor may be embedded and/or programmable. Computer processor loads executable. The executable contains an instruction set. The instruction set includes operations to perform on the video stream and/or the animated image. The operations may include adding, deleting or modifying images, character, or text.

For example, the computer processor may load the executable for audio data and sprite instructions. In one alternative, the executable may be streamed in through the media interface. In another alternative, the executable is determined based on the particular video stream and/or animated image loaded into the computer processor. In yet another alternative, the executable is pre-stored in memory. In still another alternative, user may interactively generate the executable.

In one aspect, the executable handles inputs (events) driven by an end-user. For example, the executable can respond to a key-press by an end-user. In this instance, a key-press begins changing functionality of a media-playback player's remote control unit. For example, the functionality change is adding animation upon a play option key-press on the media playback player. The media playback player functionality further includes options such as stop, pause, skip forward and back, rewind, or the like. In another aspect, the option skip forward may be morphed from its original function to a new function. An end-user by a key-press begins animating or adding sprites to a currently displayed animated image of the video stream.

In another aspect, the executable defines behaviors based on an end-user input peculiar to the currently displayed animated image of the video stream. For instance, a user pressing the “Enter” key when a currently displayed animated image is an interactive game creates a text character on a video display device. In this same example, a user pressing the “Enter” key during a currently displayed animated image is an active menu screen creating an animated character on a video display device.

Consequently, the computer processor added to a media playback device gives powerful video processing capability. This powerful video processing capacity allows an individual video producer, by pressing a key, to contribute essentially in real-time to the displayed video data. In another aspect, an end-user watching a video stream upon a key-press adds or deletes graphics and animated images. The end-user can differentiate the difference the key-press creates during one frame of a video stream compared to another.

In another aspect, video developers, like artists, authors, or producers, may each individually in essentially real-time implement their own font schemes. This implementation allows video developers additional options including drawing their text through bitmaps or vector-based fonts. Further, these video developers can add their own blending algorithms, update and change these algorithms to create a new video program.

In one aspect, the executable is associated with the animated image. In another aspect, the executable may be associated with the video stream. The loaded executable examines and/or modifies pixels stored in the RAM. In one aspect, the executable identifies pixels that need to be modified based on an end-user inputs or based on a programmed algorithm. The computer processor rapidly completes any changes to the video data stored in the computer processor memory device. These changes to the video data occur without slowing down the video stream playback rate. Thus, changes to the video stream are made in essentially real-time. The media playback device may further include extra graphics acceleration hardware to ensure high frame-rates and faster response time.

In another aspect, an animated image is created by the computer processor. In one aspect, the executable modifies the attributes of a sidecar video streamed into the media playback device. Meta-data associated with the sidecar video is used by the executable to change the sidecar video attributes. In another aspect, sidecar audio may be added to the video stream. In yet another aspect, streamed sprites and associated sprite meta data are used to create an animated image for composting with the video stream or being superimposed over the video stream. Examples of sprite meta-data include position, scale, alpha, frame state, or the like. Further, trigger data and executable may be streamed through the media interface. The sprite meta-data includes data elements, data attributes, data records, and data structures.

The computer processor receives or sends video data to a computer memory device as indicated in block 255. The computer processor may receive stored meta-data, executable, or images. In another aspect, the computer processor memory device may store audio and video data even after the audio and video data has been sent to a video display device. The computer processor memory device, in this embodiment, is a random access memory (RAM). RAM is a data storage device in which the order of accessing different memory locations within this device does not affect the speed of access. RAM provides storage for stored graphics after their initial use for a future use. In another aspect, the RAM may store executable, meta-data, or an animated image.

The computer processor outputs video output data to a media application programming interface (API) as indicated in block 260. The API accesses the computer processor for translating the video output data from the computer processor to a media demultiplexor/decoder as indicated in block 270. Media demultiplexor/decoder performs demultiplexing operations on input video data from the pre-stream buffer and media API. An audio output of the demultiplexing/decoding operation is a composite audio signal sent to an audio output buffer as indicated in block 280.

A video output of the demultiplexing/decoding operation is a composite video signal for a video output buffer as indicated in block 290. The video output buffer is a fixed memory device. Sufficient memory in the computer processor memory device maybe necessary to display a large graphics file such as a digital video picture. The large graphics file may be several screens of graphics at high-definition resolution including thousands of colors. The output video buffer contains a digital video picture before it is sent to a video display device. The video display device may be a Liquid Crystal Display (LCD).

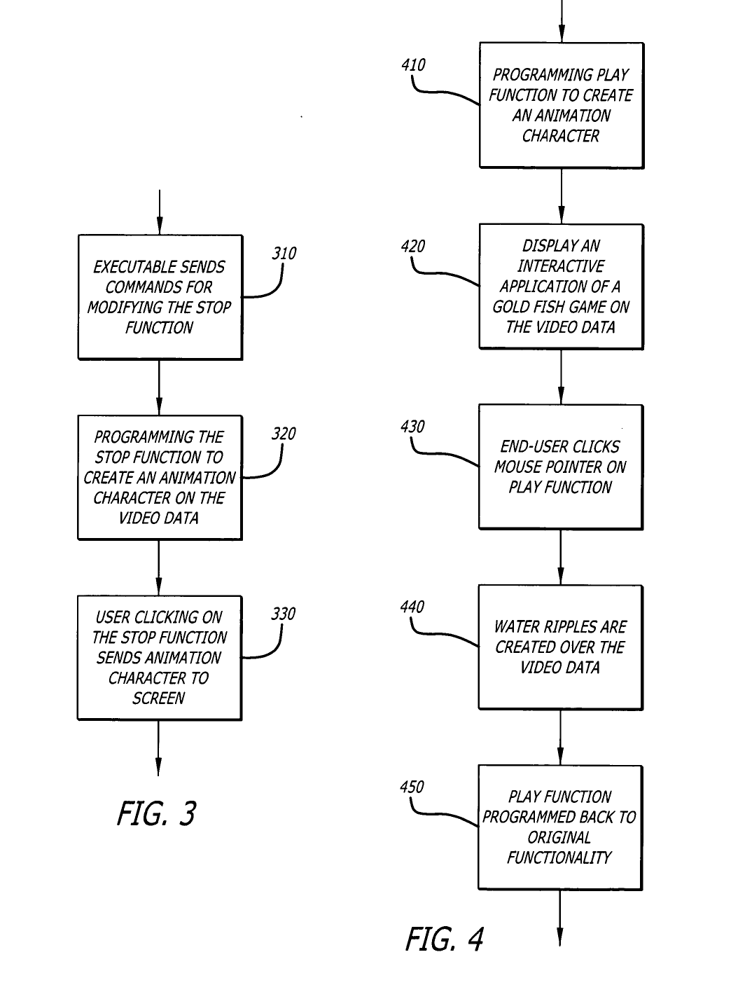

FIG. 3 is a flow diagram illustrating media playback device functionality being modified in response to instructions from the computer processor. Executing the executable sends instructions to modify the stop function as indicated in block 310. In this instance, the stop function is programmed to create an animation character on a video display device as indicated in block 320. During the video stream, a user clicking with a mouse pointer on the stop function while a video stream sends animation characters to a video display device as indicated in block 330.

FIG. 4 is a flow diagram illustrating the functionality of a media playback device modified by an interactive application in response to executing the executable. In this example, the interactive application displays a video of a goldfish game, which is played over a video stream as indicated in block 410. In this example, an end-user desires to locate a hidden treasure within a pond as indicated in block 420. An end-user clicks with mouse pointer on the play function located on a video display device as indicated in block 430. The clicking by an end-user causes execution of executable and analysis of meta-data associated with the play function. The executable reprograms the play function. On the video display, ripples appear as if surface of the water has been displaced by a touch of a human finger and the hidden treasure appears as indicated in block 440. Afterwards, the meta-data associated with the play function restores the media playback device to its original functionality as indicated in block 450.

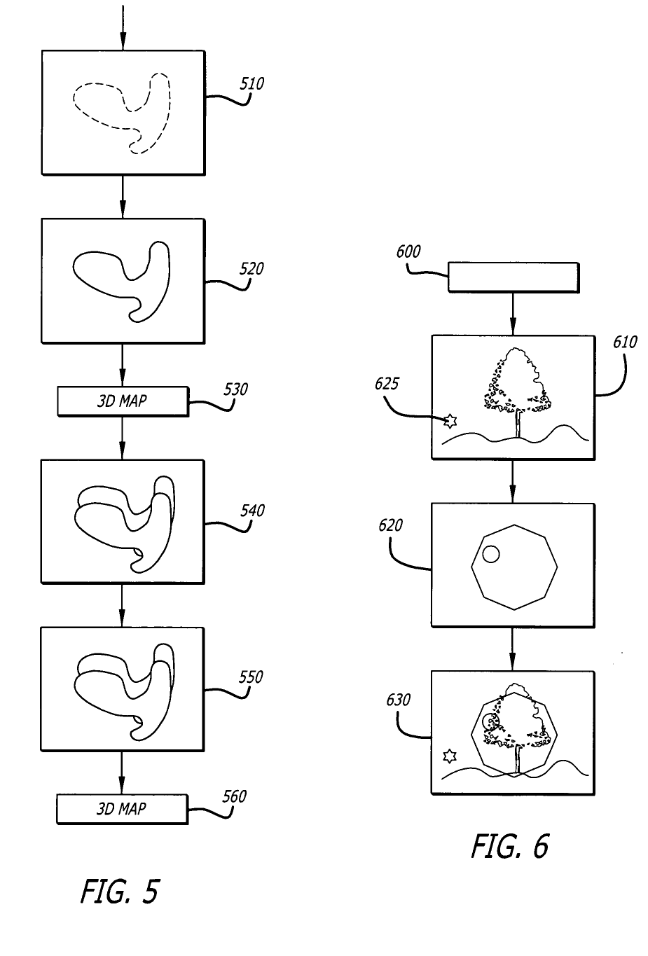

FIG. 5 is a flow diagram illustrating blending of 2-dimensional and 3-dimensional representations on a screen shot. The executable running on computer processor might include a 3D rendering executable. This system could be leveraged to create exciting blends between the 2-dimensional (2D) and 3-dimensional (3D) representations of a graphics file or a character image.

In one aspect, executable and meta-data associated with a non-interactive gold fish (2D gold fish) image located in the video stream is received by the media playback device. The executable executes on the computer processor an edge detection algorithm to locate the non-interactive goldfish in the video stream as indicated in block 510. The executable copies the non-interactive goldfish into a memory device as indicated in block 520. The memory device may be the computer processor memory device or the pre-buffer memory device or any equivalent. In one aspect, the meta-data and the executable may be stored in the computer processor or the pre-buffer memory device or any equivalent. In this example, the executable examines and/or modifies pixels of the 2D gold fish image stored in the memory device. The executable converts the 2D goldfish image into a 3D texture map as indicated in block 530. The 3D texture map creates the 3D goldfish model. The 2D goldfish image is replaced with a 2D image of an empty tank as indicated in block 540. An edge detection algorithm identifies the edge for rendering the 3D goldfish model to the position of the 2D goldfish image. The 3D goldfish model is interactive with an end-user input and/or the computer processor as indicated in block 550. The 3D goldfish image is then mapped to a mouse pointer as indicated in block 560. In an additional aspect, the executable modifies the key-press functionality. In this aspect, using the key-press command guides the interactive fish (3D goldfish model) around the video tank using a key-press command.

In another aspect, animated morphing is possible. For instance, a video developer may desire the video playback device functionality to pop out of the background of a video stream upon pressing the menu key. In another example, an interactive application converts a user's press on a menu key to begin animating the video display. In yet another example, a user presses the play key on the video playback device. In this example, an interactive application morphs a wooden sign on the video stream in any or all the following attributes including shape, color and position. Thus animated morphing allows a video developer to create interactive applications controlled by an end-user.

FIG. 6 is a flow diagram illustrating a user-controlled character being programmed by the computer processor. In this example, a video designer and/or a video developer creates an animated, user-controlled character that walks behind a foreground element in the video stream. In one aspect, the executable running on the computer processor uses chroma information or an edge detection algorithm. The algorithm finds the foreground element, such as tree, as indicated in block 600. An animated interactive character is copied into video buffer as indicated in block 610. Portions of the animated interactive character that should appear behind tree are not copied as indicated in block 620. Consequently, the animating interactive character appears behind the tree and in the video stream. The animated interactive character could also interact with the world of the video programmatically. The behaviors of animating character could be controlled and synchronized with an object in the video stream (background video). Pre-recorded scripts interpreted by the executable executing within the media playback device provides the control and the synchronization routines.

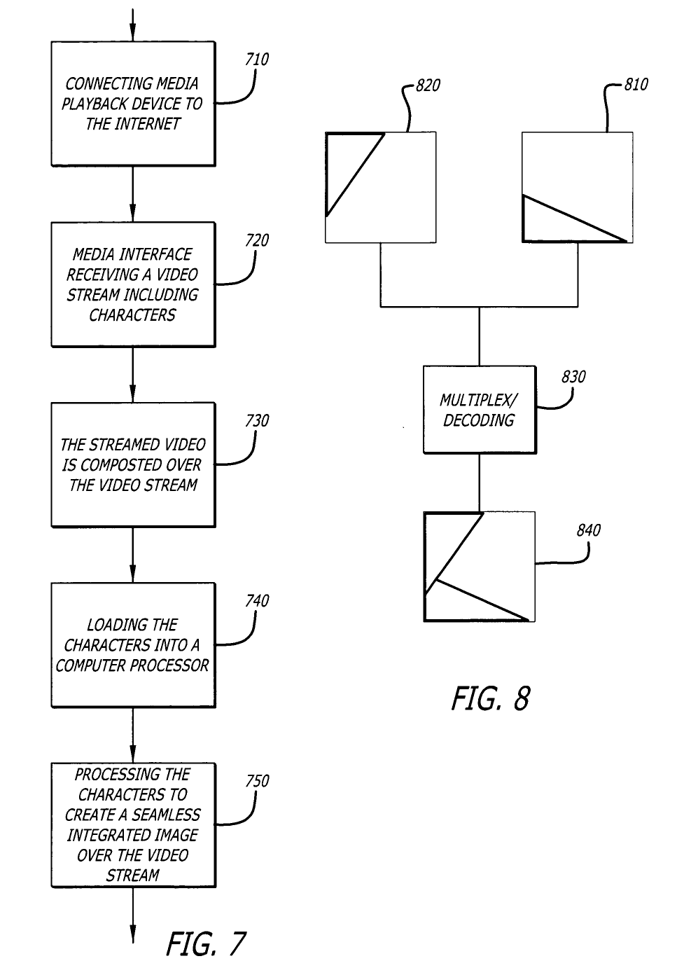

FIG. 7 is a flow diagram illustrating image received from the Internet being composited over the video stream. The inclusion of the computer processor allows for other exciting features. In this instance, the media playback device is connected to the Internet as indicated in block 710. The streamed video including meta-data, executable, and/or images arrive through Internet protocols. The streamed video flows through the media interface as indicated in block 720. The streamed video is composited over the video stream as indicated in block 730. The characters received from the Internet connection are stored in a memory device such as the computer processor memory device or the pre-stream buffer. The characters are loaded into the computer processor as indicated in block 740. Afterwards, the executable processes the characters for seamlessly integrating over the video stream. The characters appear composited with video stream as indicated in block 750.

FIG. 8 is flow diagram showing snapshots of a picture-in-picture system being composited into a third video stream. In one aspect, video data, such as meta-data and executable associated with the first and the second video stream, are received by the media playback device providing an instruction set and attributes for creating a picture-in-picture system. Upon execution of the executable, a first video stream and a second video stream are multiplexed together while the first video stream is being decoded as indicated in block 810. Once decoded, second video stream is composited on the first video stream as indicated in block 820. The resulting composite image is a third video stream as indicated in block 830.

The foregoing description of the preferred embodiments of the disclosure has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto; wherein reference to an element in the singular is not intended to mean “one and only one” unless explicitly so stated, but rather “one or more.”

All structural and functional equivalents to the elements of the above-described embodiment and additional embodiments that are known to those of ordinary skill in the art are hereby expressly incorporated by reference and are intended to be encompassed by the present claims. Moreover, no requirement exists for a device or method to address each and every problem sought to be resolved by the present invention, for such to be encompassed by the present claims.

Furthermore, no element, component, or method step in the present disclosure is intended to be dedicated to the public regardless of whether the element, component, or method step is explicitly recited in the claims. However, one skilled in the art should recognize that various changes and modifications in form and material details may be made without departing from the spirit and scope of the inventiveness as set forth in the appended claims. No claim herein is to be construed under the provisions of 35 U.S.C. § 112, sixth paragraph, unless the element is expressly recited using the phrase “means for.”

1. A method for dynamically generating an animated image for insertion into a video comprising:
receiving an image;
receiving meta-data defining attributes associated with a sprite;
receiving an executable;
providing the image as a first input to the executable;
providing the metadata as a second input to the executable; and
generating the sprite by executing the executable, wherein the sprite is superimposed over a video stream.

2. The method as recited in claim 1 further including the step of storing the animated image in a memory device for future use.

3. The method as recited in claim 1 further including the step of storing the meta-data and the executable in a memory device for future use.

4. The method as recited in claim 1 wherein the meta-data comprises sprite identifiers and sprite states.

5. The method as recited in claim 1 wherein the meta-data comprises stretch and skew information.

6. The method as recited in claim 1 further including the steps of
receiving meta-data associated with the video stream,
executing the executable associated with the video stream, and
analyzing the meta-data associated with the video stream in essentially real-time to update the attributes of the video stream.

7. The method as recited in claim 1 further including receiving trigger data associated with the sprite for defining location for placement of the sprite within the video stream.

8. The method as recited in claim 1 wherein executing the executable redefines basic functionality of a video playback device in response to the seamlessly integrated image.

9. The method as recited in claim 1 wherein executing the executable interactively redefines basic functionality of a media playback device in response to an end-user input.

10. The method as recited in claim 1 wherein the sprite includes visual effects and interactive characters that appear to originate from the video stream.

11. The method as recited in claim 1 wherein the sprite is an interactive image that seamlessly transitions from the video stream.

12. The method as recited in claim 1 wherein executing the executable performs real-time analytical logic operations on a digital video picture before the digital video picture is sent to the video display device.

13. The method as recited in claim 1 wherein the executable includes an image blending algorithm that seamlessly transitions the sprite with the video stream.

14. The method as recited in claim 1 wherein the executable includes an image edge detection algorithm to locate non-interactive image, and seamlessly replace the non-interactive image with an animated image.

15. The method as recited in claim 1 further including providing a video playback device including a video buffer that electrically couples to a computer processor for holding a digital video picture before being sent to a video display device.

16. A method for seamlessly integrating an animated interactive image into a video stream comprising:
receiving executable and meta-data associated with an animated interactive image for defining behavior of the media playback device;
executing the executable utilizing meta-data associated with the animated interactive image to create the animated interactive image;
redefining the behavior of the media playback device in essentially real-time in response to the meta-data and the executable;
compositing in real-time the video stream with the animated interactive image;
generating a seamlessly integrated image of the video stream and the animated interactive image; and
storing the meta-data and the executable in a memory device for future use.

17. The method as recited in claim 16 wherein the animated interactive image is an animated interactive character synchronized with background video objects through pre-recorded scripts that are interpreted by the executable.

18. The method as recited in claim 16 further including the steps of receiving the meta-data and the executable though an Internet protocol.

19. The method as recited in claim 16 further including the step of triggering the animated interactive image at various times during the duration of the video stream for creating an end-user interactive functionality with the media playback device.

20. The method as recited in claim 16 further including the steps of:
receiving meta-data for defining attributes of a video stream;
receiving executable associated with the video stream;
executing the executable associated with the video stream; and
analyzing the meta-data associated with the video stream in essentially real-time to update the properties of a video stream

21. A media device comprising:
a media interface for receiving video data;
a programmable computer processor electrically coupled to the media interface for receiving video data;
an executable executed by the programmable computer processor for creating an animated interactive image based on received streamed metadata and executable associated with the animated interactive image, redefining the functionality of the media device user inputs; and compositing in real-time a seamlessly integrated image of the video stream and the animated interactive image; and
a memory device electrically coupled to the programmable computer processor for storing the meta-data and the executable for future use.

22. The media device as recited in claim 21 wherein the animated interactive image is based on an end-user input.

23. The media device as recited in claim 21 wherein the memory device is a Random Access Memory (RAM) device and the animated image is a persistently stored image.

24. A method for dynamically generating an animated image for insertion into a video stream comprising:
receiving an image;
providing a video playback device including a computer processor;
receiving meta-data for defining attributes of an animated image;
receiving executable associated with the animated image;
executing the executable associated with the animated image and analyzing the meta-data for in essentially real-time creating the animated image;
compositing in real-time a video stream with the animated image; and generating a seamlessly integrated image of the video stream and the animated image.

25. The method as recited in claim 24 further including the step of storing the animated image in a memory device for future use.

26. The method as recited in claim 24 further including the step of storing the meta-data and the executable in a memory device for future use.
